(19) United States
(12) Patent Application Publication
(10) Pub. No.: US 2007/0221895 A1
(43) Pub. Date: Sep. 27, 2007

(54) Lifting Device

(76) Inventors: Konrad Pieger, Kirchehrenbach (DE); Paul Weidner, Pressath (DE)

Correspondence Address: BRINKS HOFER GILSON & LIONE, P.O. BOX 10395, CHICAGO, IL, 60610, US

(21) Appl. No.: 10/594,745

(22) PCT Filed: Mar. 16, 2005
(86) PCT No.: PCT/EP05/51223

§ 371 Date: Sep. 28, 2006

(30) Foreign Application Priority Data
Apr. 5, 2004 (DE) 10 2004 016 728.1

(51) Int. Cl. B66F 3/00

(52) U.S. Cl. 254/124

(57) ABSTRACT

A lifting device is provided. The lifting device includes a top part and a bottom part. A lifting linkage connects the top part to the bottom part and has at least two sub-linkages connected to one another via a central articulation. A drive unit is operable to adjust the height of the top part and act on the central articulation.

The present patent document is a continuation of PCT Application Serial Number PCT/EP2005/051223, filed Mar. 16, 2005, designating the United States, which is hereby incorporated by reference.

### BACKGROUND

1. Field

The present embodiments relate to a lifting device.

2. Related Art

Lifting devices are generally known from the prior art. For example, WO 98/46137 discloses a lifting device that adjusts the height of a patient support. Parallelogram structures are used as lifting linkages. The known structures require a large amount of installation space. Large lifting forces are necessary for height adjustment. These lifting forces are not constant. Different displacement speeds arise during height adjustment. The known solutions, for example, are too large, involve too much design outlay and require excessively complicated controls.

### SUMMARY

In one embodiment, a lifting device includes a top part and a bottom part. A lifting linkage connects the top part to the bottom part and has at least two sub-linkages connected to one another via a central articulation. A drive unit is operable to adjust the height of the top part and act on the central articulation.

The drive unit acts on a central articulation of a multi-part lifting linkage. This allows the lifting device to be of particularly straightforward and compact construction.

In one embodiment, a scissors structure is used as a sub-linkage (lifting rod). The amount of installation space which is required for the lifting device is greatly reduced in comparison to the known constructions. In another embodiment, the lifting linkage comprises two scissors structures connected to one another in an articulated manner. This double scissors structure may be used to adjust the height of a top part, for example, a patient support, provided on the top scissors assembly. In this embodiment, the top part can be adjusted in an extremely confined amount of space.

In another embodiment, it is also possible to use, for example, a triple or quadruple scissors mechanism. A multiple scissors structure has a high level of rigidity and bending strength when laterally occurring forces are absorbed.

In one embodiment, the drive unit is designed to provide a rectilinear movement of the central articulation (joint) in the vertical direction. The drive unit is provided directly beneath the central articulation. The drive unit provides a constant displacement speed to the central articulation. The drive unit provides operative forces and particularly precise synchronization to the central articulation. In this embodiment, because a single drive unit is used, there is no need for a separate synchronization control. In this embodiment, the lifting device does not require arcuate pivoting of the lifting linkage or an associated need for more space.

In another embodiment, the drive unit has a spindle and a motor. A spindle and a motor have relatively less maintenance than a hydraulic cylinder. In one embodiment, a vertically running spindle is driven, via a corresponding gear mechanism, by an electric motor with its axis of rotation perpendicular to the spindle axis. This embodiment allows a space-saving construction of the lifting device.

In one embodiment, the spindle is a trapezoidal spindle. The spindle is not limited to a self-locking type of spindle. Other spindles may be used, for example, ball screw spindles. In one embodiment, the spindle, motor and gear mechanism are embodied such that the spindle flanks are always subjected to the load. Hydraulic cylinders have varying operating paths depending on design. In one embodiment, the drive unit is fixed, for example, there is no return play.

In another embodiment, the motor is fastened on the bottom part, for example, on a base plate. Accordingly, there is sufficient space for the motor-control above the motor and there is no need for any moveable cable guide.

In an alternative embodiment, a moveable motor is fastened on the central articulation and moves up and down on the spindle.

### BRIEF DESCRIPTION OF THE DRAWINGS

FIG. 1 illustrates a perspective view of lifting device according to a first embodiment,

FIG. 2 illustrates a perspective view of a lifting device according to a second embodiment, and

FIG. 3 illustrates a plan view of a lifting device according to the second embodiment.

### DETAILED DESCRIPTION

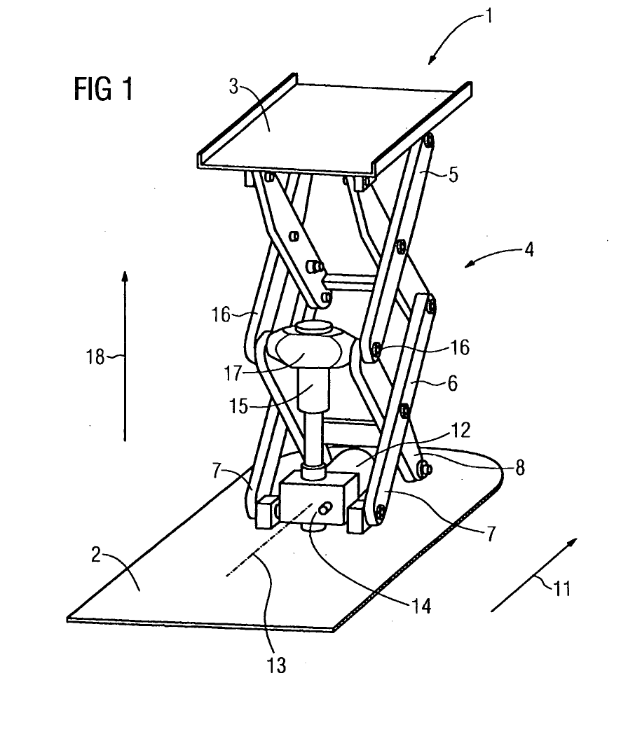

In one embodiment, as shown in FIG. 1, a lifting device 1 includes a bottom part, in the form of a base plate 2, a top part, in the form of a patient support 3, and a lifting linkage. The lifting linkage is configured as a double scissors mechanism or double scissors structure 4. The double scissors structure 4 comprises, for example, two scissors assemblies 5, 6 as sub-linkages, which are connected to one another by a central articulation (joint) 16.

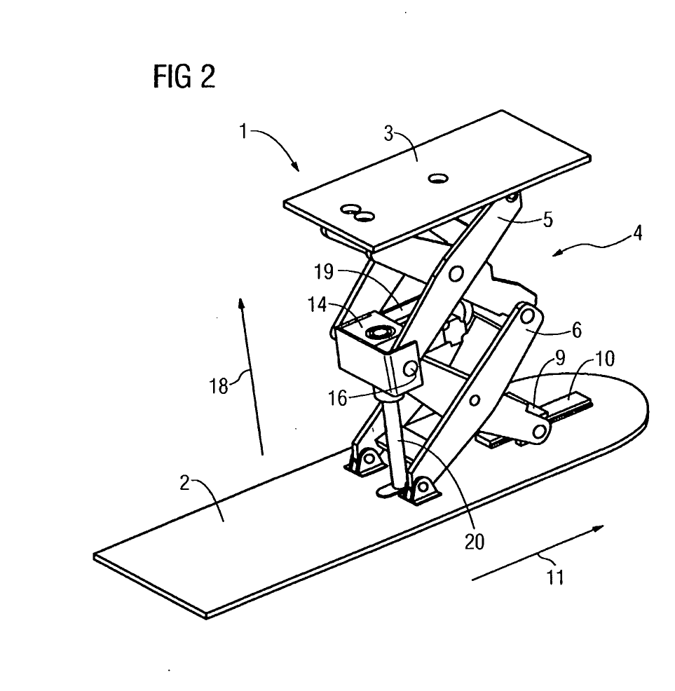

The bottom scissors assembly 6 is supported by the base plate 2. The bottom scissors assembly 6 includes front scissor feet 7 and rear scissor feet 8. The front scissor feet 7 are connected to the base plate 2. As shown in FIG. 2, the rear scissors feet 8 of the bottom scissors assembly 6 are connected to one another via a slide 9. For example, when the double scissors structure 4 is opened and closed, the slide runs back and forth in the running direction 11 on a running rail 10 fastened on the base plate 2.

In one embodiment, a horizontally arranged electric motor 12 is fastened on the base plate 2 between the front and the rear scissors feet 7, 8 of the bottom scissors assembly 6. In an alternate embodiment, a hand crank (not illustrated) for emergency operation of the lifting device 1 is attached at that end of the electric motor 12 which is directed toward the rear scissors feet 8. The axis of rotation 13 of the electric motor 12 runs parallel to the running direction 11 of the slide 9. There is sufficient space for arranging a motor-controller (not depicted) above the electric motor 12. A toothed gear mechanism 14 that converts the rotary movement of the electric motor 12 into a linear movement of a telescopic spindle 15 is located between the front scissors feet 7. The spindle 15 is operable perpendicular to the axis of rotation 13 of the electric motor 12 and is arranged between the front scissors feet 7 and beneath the front central articulation 16 of the double scissors structure 4. In one embodiment, the spindle 15 is designed as a trapezoidal screw spindle (ACME spindle) and has its spindle head connected in an articulated manner to the front central articulation 16 of the double scissors structure 4 via a transverse connection 17. In another embodiment, the spindle 15 is a telescopic spindle.

For example, for a height adjustment of the patient support 3, the electric motor 12 is switched on and the telescopic spindle 15 is extended and retracted. The central articulation 16 of the double scissors structure 4 executes a rectilinear movement in the vertical direction 18 at a constant displacement speed and the slide 9 moves in the running direction 11. The axis of rotation 13 of the electric motor 12 runs perpendicular to the spindle 15 axis. In one embodiment, the gear mechanism 14 is a self-locking gear mechanism. The spindle flanks are subjected to load and the telescopic spindle 15 does not exhibit any return play. The absolute-value sensor of a measuring system is fitted directly (not depicted) on the telescopic spindle 15.

In an alternative embodiment, as shown in FIG. 2, the lifting device includes a moveable motor 19. In this embodiment, the electric motor 19 is fixed on the central articulation 16 of the double scissors structure 4. For example, when the double scissors structure 4 opens and closes, the electric motor 19 moves up and down on a screw spindle 20 fixed on the base plate 2.

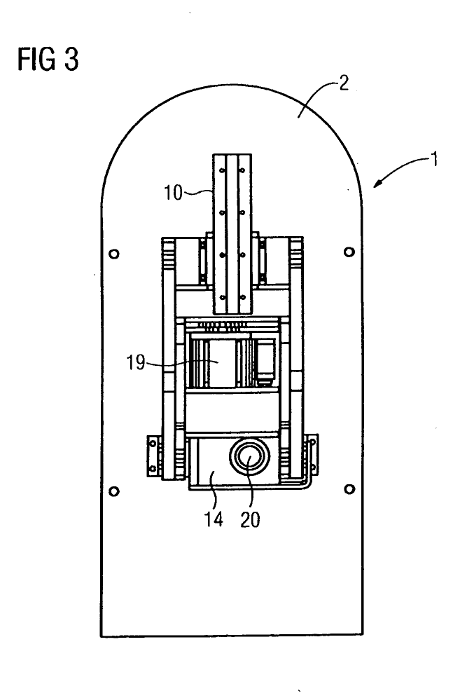

As shown in FIG. 3, a lifting device 1 requires only a particularly small base surface area.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A lifting device comprising:
a top part and a bottom part,
having a lifting linkage that connects the top part to the bottom part and has at least two sub-linkages connected to one another via a central articulation, and
a drive unit that is operable to adjust the height of the top part, and act laterally on the central articulation such that the lifting linkage is displaced in the vertical direction, the lifting linkage being supported on the bottom part by way of spaced-apart scissors feet of the bottom sub-linkage.

2. The lifting device as claimed in claim 1, in that the drive unit has a spindle which is fastened on the central articulation, and a motor.

3. The lifting device as claimed in claim 2, wherein the spindle is a trapezoidal spindle.

4. The lifting device as claimed in claim 2, wherein the motor is fastened on the bottom part.

5. The lifting device as claimed in claim 2, wherein the motor is fastened on the central articulations.

6. The lifting device as claimed in claim 1 wherein the sub-linkage is connected to the bottom part in an articulated manner by front scissors feet and is fastened on the bottom part by rear scissors feet such that the sub-linkage runs over the bottom part when the height of the top part is adjusted.

8. A method of adjusting the height of a top part of a lifting device, the method comprising using a drive unit, the top part being connected to a bottom part via a lifting linkage and the lifting linkage having at least two sub-linkages are connected to one another via a central articulations and are scissors structures, characterized in that the drive unit acts laterally on the central articulation such that the central articulation and thus the lifting linkage, are displaced in the vertical direction, the lifting linkage being supported on the bottom part by way of spaced-apart scissors feet of the bottom sub-linkage.

9. The lifting device as claimed in claim 1, wherein the central articulation moves rectilinearly.

10. The lifting device as claimed in claim 1, wherein one of the at least two sub-linkages connected to the bottom part.

11. The lifting device as claimed in claim 10, wherein the one of the at least two sub-linkages comprises front feet fastened on the bottom part and rear scissor feet that are operable to slide over the bottom part when the height of the top part is adjusted.
